(19) United States
(12) Patent Application Publication
(10) Pub. No.: US 2026/0246860 A1
(43) Pub. Date: Aug. 20, 2026

(54) FOLDABLE ELECTRONIC DEVICE

(71) Applicant: HUAWEI TECHNOLOGIES CO., LTD., Shenzhen (CN)

(72) Inventors: Lijun Ying, Shanghai (CN); Liang Xue, Shanghai (CN); Dong Yu, Shanghai (CN); Hanyang Wang, Reading (GB)

(73) Assignee: HUAWEI TECHNOLOGIES CO., LTD., Shenzhen (CN)

(21) Appl. No.: 19/647,243

(22) Filed: Apr. 14, 2026

Related U.S. Application Data
(63) Continuation of application No. PCT/CN2024/118711, filed on Sep. 13, 2024.

(30) Foreign Application Priority Data
Dec. 25, 2023 (CN) 202311811542.2

(51) Int. Cl. H04M 1/02; H04B 1/00

(52) U.S. Cl. CPC H04M 1/0206; H04B 1/0064

(57) ABSTRACT

Example foldable electronic devices are provided. An example foldable electronic device includes an antenna apparatus including a first radiator, a second radiator, a first feeding circuit, a second feeding circuit, and a first tuning circuit. A length of the second radiator between a third open end and a second open end is greater than a length of the first radiator between a ground end and a first open end. When the electronic device is in a folded state, projections of the first open end and the second open end at least partially overlap, and a projection of the ground end is located between a first ground point and the second open end. The first tuning circuit is configured to adjust a second operating frequency band to be the same as or adjacent to a first operating frequency band.

### CROSS-REFERENCE TO RELATED APPLICATIONS

This application is a continuation of International Application No. PCT/CN 2024/118711, filed on Sep. 13, 2024, which claims priority to Chinese Patent Application No. 202311811542.2, filed on Dec. 25, 2023. The disclosures of the aforementioned applications are hereby incorporated by reference in their entireties.

### TECHNICAL FIELD

This application relates to the field of communication technologies, and specifically, to a foldable electronic device.

### BACKGROUND

In a foldable electronic product such as a foldable mobile phone, antennas are arranged on two sides of a rotating shaft in some models. When the mobile phone is in a folded state, the antennas on the two sides of the rotating shaft are close to each other. As a result, when the two antennas operate independently, isolation deteriorates, and antenna performance deteriorates.

### SUMMARY

In view of this, this application provides a foldable electronic device, to implement good isolation between antennas located on two sides of a rotating shaft when the foldable electronic device is in a folded state.

An embodiment of this application provides a foldable electronic device, where the electronic device includes an antenna apparatus, a first body, a second body, and a rotating shaft, the first body and the second body are respectively disposed on two sides of the rotating shaft and are rotatively connected to the rotating shaft, the first body includes a first ground plane, and the second body includes a second ground plane. The antenna apparatus includes: a first radiator, a second radiator, a first feeding circuit, a second feeding circuit, and a first tuning circuit. The first radiator is disposed on the first body, where the first radiator is provided with a ground end and a first open end, the ground end is coupled to the first ground plane, and the first radiator includes a first feeding point. The first feeding circuit is coupled to the first radiator through the first feeding point, and configured to feed a signal of a first operating frequency band to the first radiator, where the first radiator is configured to generate a first resonance corresponding to the first operating frequency band. The second radiator is disposed on the second body, where the second radiator is provided with a second open end, a third open end, and a first ground point located between the second open end and the third open end, the first ground point is coupled to the second ground plane, a ratio of a length of the second radiator between the second open end and the third open end to a length of the first radiator between the ground end and the first open end is greater than 1 and less than or equal to 2, and the second radiator includes a second feeding point. The second feeding circuit is coupled to the second radiator through the second feeding point, and configured to feed a signal of a second operating frequency band to the second radiator, where the second radiator is configured to generate a second resonance corresponding to the second operating frequency band, and the second operating frequency band is the same as or adjacent to the first operating frequency band. One end of the first tuning circuit is coupled to the second radiator, the other end is coupled to the second ground plane, and the first tuning circuit is configured to adjust the second resonance of the second radiator to correspond to the second operating frequency band. When the electronic device is in a folded state, projections of the first open end and the second open end at least partially overlap in a thickness direction of the electronic device, and a projection of the ground end is located between a projection of the third open end and the projection of the second open end.

In this application, the first tuning circuit is connected at the second feeding point of the second radiator, so that a resonance frequency band of the second radiator can be adjusted to be the same as or adjacent to a resonance frequency band of the first radiator through the first tuning circuit. In addition, the length of the second radiator between the third open end and the second open end is greater than the length of the first radiator between the ground end and the first open end. In the folded state of the electronic device, the projections of the first open end and the second open end at least partially overlap in the thickness direction of the electronic device, and the projection of the ground end is located between the first ground point and the second open end. When the first feeding circuit feeds the first radiator through the first feeding point, and the second feeding circuit feeds the second radiator through the second feeding point, electric field strong points can be formed at both the first open end and the second open end. In addition, because the projections of the first open end and the second open end in the thickness direction of the electronic device at least partially overlap, the electric field strong point at the first open end and the electric field strong point at the second open end can be coupled to each other, and a first current path is generated. In addition, the ground end of the first radiator and the first ground point of the second radiator are respectively current strong points. The current strong points of the two radiators may be coupled to form a second current path. Directions of the first current path and the second current path are reverse to each other. Therefore, when the first current path and the second current path meet a phase cancellation condition, isolation between the two radiators is good when the two radiators operate in a same frequency band or adjacent frequency bands, so that the two radiators can operate independently and normally in the folded state of the electronic device.

In a possible implementation, the second radiator includes a second ground point, and the second ground point is disposed between the first ground point and the second feeding point. The antenna apparatus further includes a second tuning circuit, where one end of the second tuning circuit is connected to the second ground point, and the other end is connected to the second ground plane. The second tuning circuit may adjust an efficiency dip of the second radiator, so that the efficiency dip of the second radiator becomes shallow or moves out of a band, so that the two radiators have high isolation, and the two radiators can obtain good antenna performance.

In a possible implementation, the second tuning circuit includes a capacitor and/or an inductor and/or a radio frequency switch. The second tuning circuit may include a capacitor or an inductor, or may be formed by combining a capacitor and an inductor, or include a radio frequency switch. The radio frequency switch has a plurality of branches, and each branch may be connected to a capacitor or an inductor, so that a design of the second tuning circuit is more flexible, and can be adapted to a plurality of application scenarios.

In a possible implementation, when the electronic device is in the folded state, in the thickness direction of the electronic device, the projection of the ground end is at least partially located between a projection of the first ground point and a projection of the second ground point. The ground end, the first ground point, and the second ground point are staggered from each other, so that ground return paths of the ground end and the first ground point are different. This helps improve isolation between the first radiator and the second radiator during operation. In addition, the ground return paths of the ground end and the second ground point are different, which helps adjust the efficiency dip by using the second tuning circuit connected to the second ground point, so that the current paths of the first radiator and the second radiator meet a phase cancellation condition, and better isolation can be obtained when the first radiator and the second radiator each operate independently in the folded state of the electronic device.

In a possible implementation, the ground end is electrically connected to the first ground plane. The electrical connection means that the ground end and the first ground plane are directly electrically connected, or the ground end and the first ground plane are electrically connected through a physical element, so that quality of energy transmission can be ensured.

In a possible implementation, the first radiator, the ground end, and at least a part of the first ground plane are integrally formed, so that reliability of a structural connection between the first radiator, the ground end, and the first ground plane can be ensured, and a processing process can be simplified, thereby improving processing precision. In an embodiment, a middle frame of an electronic device such as a mobile phone is an integrated structure, and some parts of the middle frame may be reused as the first radiator, the ground end, and the first ground plane in this application. In an implementation, the first ground plane may be a middle plate part of the middle frame in the electronic device such as the mobile phone.

In a possible implementation, an electrical length of the first radiator between the ground end and the first open end is 1/4λ, where λ is a wavelength corresponding to a range of the first operating frequency band. The first radiator having the electrical length can not only obtain good signal receiving and sending quality, but also have a small structure size, thereby facilitating a miniaturization design of the antenna apparatus.

In a possible implementation, an electrical length of the second radiator between the first ground point and the second open end is between 1/4λ and 1/2λ, where λ is a wavelength corresponding to a range of the second operating frequency band. The second radiator has a larger electrical length than the first radiator, which helps improve isolation between the first radiator and the second radiator when the first radiator and the second radiator operate independently, and can ensure that the second radiator obtains good signal receiving and sending quality, thereby facilitating structure miniaturization.

In a possible implementation, the antenna apparatus further includes a third tuning circuit, where one end of the third tuning circuit is connected to the first radiator, and the other end is connected to the first ground plane. The third tuning circuit may adjust a resonance frequency of the first radiator, so that the resonance frequency of the first radiator is lowered, and the resonance frequency of the first radiator is the same as or adjacent to a resonance frequency of the second radiator.

In a possible implementation, the third tuning circuit includes a capacitor and/or an inductor and/or a radio frequency switch, and is configured to adjust the first resonance to correspond to the first operating frequency band. The third tuning circuit and the foregoing first tuning circuit may have a similar structure. In other words, the third tuning circuit may also include a capacitor or an inductor, or may be formed by a combination of a capacitor and an inductor, or include a radio frequency switch. The radio frequency switch has a plurality of branches, and a capacitor or an inductor may be connected to each branch. Therefore, a design of the third tuning circuit is more flexible, and is conducive to meeting a plurality of application scenarios. In a process of adjusting performance parameters of the first radiator and the second radiator, the first resonance of the first radiator may be first adjusted to correspond to the first operating frequency band through the third tuning circuit, and then the second tuning circuit connected to the second ground point on the second radiator may be adjusted. The efficiency dip of the second radiator may be adjusted through the second tuning circuit, so that the efficiency dip of the second radiator becomes shallow or moves out of a band, so that the second radiator and the first radiator have good isolation. Then, the first tuning circuit is adjusted, so that the second resonance of the second radiator is located in the corresponding second operating frequency band. The second operating frequency band is the same as or adjacent to the first operating frequency band, so that isolation between the first radiator and the second radiator is good when the first radiator and the second radiator operate independently at a same frequency or adjacent frequencies, and good antenna performance can be obtained.

In a possible implementation, the second tuning circuit includes a first inductor, the third tuning circuit includes a second inductor, and an inductance value of the first inductor is less than an inductance value of the second inductor, so that the resonance frequencies of the first radiator and the second radiator can be adjusted to a same frequency or adjacent frequencies, to implement intra-frequency or adjacent-frequency operation of the first radiator and the second radiator.

In a possible implementation, a distance between the first feeding point and the first open end is less than 7.5 mm, and a distance between the second feeding point and the second open end is less than 7.5 mm. In this way, the first feeding point may be closer to the first open end, and the second feeding point may be closer to the second open end, so that the first radiator forms an electric field strong point at the first open end, and the second radiator forms an electric field strong point at the second open end. When the electronic device is in the folded state, the electric field strong point of the first radiator and the electric field strong point of the second radiator can be coupled to each other to form a current path, so that the current path can cancel another current path formed by coupling ground ends of the two radiators, thereby improving isolation between the two radiators when the two radiators operate independently.

In a possible implementation, an electrical length between the first feeding point and the first open end is less than 1/8λ, where λ is a wavelength corresponding to the range of the first operating frequency band. An electrical length between the second feeding point and the second open end is less than 1/8λ, where λ is a wavelength corresponding to the range of the second operating frequency band. In this way, the first feeding point may also be closer to the first open end, and the second feeding point may also be closer to the second open end. Details are not described herein again.

In a possible implementation, the first radiator is disposed on a side that is of the first body and that is away from the rotating shaft, and the second radiator is disposed on a side that is of the second body and that is away from the rotating shaft. When the electronic device is in a flattened state, there is a large distance between the first radiator and the second radiator, so that isolation between the first radiator and the second radiator is good when the first radiator and the second radiator operate independently. When the electronic device is in the folded state, the first radiator and the second radiator are close, and the path formed by coupling the electric field strong points of the two radiators and another current path formed by coupling the current strong points of the two radiators cancel each other, so that isolation between the two radiators is good when the two radiators operate independently.

In a possible implementation, the first radiator is disposed on a side that is of the first body and that is adjacent to the rotating shaft, the second radiator is disposed on a side that is of the second body and that is adjacent to the rotating shaft. In an axial direction of the rotating shaft, both the first radiator and the second radiator are located on a same side of the electronic device. When the electronic device is in the flattened state, there may also be a large distance between the first radiator and the second radiator, so that isolation between the first radiator and the second radiator is good when the first radiator and the second radiator operate independently. When the electronic device is in the folded state, the first radiator and the second radiator are close, and the path formed by coupling the electric field strong points of the two radiators and the another current path formed by coupling the current strong points of the two radiators cancel each other, so that isolation between the two radiators is good when the two radiators operate independently.

In a possible implementation, the antenna apparatus further includes a fourth tuning circuit, one end of the fourth tuning circuit is connected to the first ground point, and the other end is connected to the second ground plane. The fourth tuning circuit helps adjust the efficiency dip of the second radiator, so that the second radiator and the first radiator have good isolation.

In a possible implementation, the fourth tuning circuit includes a capacitor and/or an inductor and/or a radio frequency switch, and is configured to adjust the efficiency dip of the second radiator. In a possible implementation, the fourth tuning circuit may cooperate with the second tuning circuit to perform adjustment, which helps improve adjustment precision of the efficiency dip, and can better match isolation between the first radiator and the second radiator.

In a possible implementation, the antenna apparatus further includes a parasitic stub, where the parasitic stub is disposed on a side that is of the first radiator and that has the first open end, and there is a first gap between the parasitic stub and the first open end; or the parasitic stub is disposed on a side that is of the second radiator and that has the second open end, and there is a first gap between the parasitic stub and the second open end. The first radiator and the second radiator have a same structure, and are symmetrically disposed on the corresponding first body and second body. The parasitic stub can attract a current, to create an asymmetric current path between two radiators that are symmetric in structure and position, thereby generating a cancellation current, improving isolation between the two radiators in an independent operating process, and further expanding a bandwidth.

In a possible implementation, a frequency of a resonance point of the first resonance is higher than a frequency of a resonance point of the second resonance.

In a possible implementation, a minimum difference between a frequency of the first operating frequency band and a frequency of the second operating frequency band is less than or equal to 200 MHz. If the first radiator and the second radiator use a same structure and are symmetrically disposed in the electronic device, in the folded state of the electronic device, when a difference between resonance frequencies of the two radiators is within 200 MHz, isolation between the two radiators is poor, and good radiation performance cannot be achieved. In this application, the resonance frequency of the second radiator can be adjusted to be the same as or adjacent to the resonance frequency of the first radiator by using the first tuning circuit, so that the difference between the resonance frequencies can be within 200 MHz. In addition, a distance between the second radiator and the first ground point at the second open end is greater than a distance between the first radiator and the ground end at the first open end, so that current paths can be canceled, and isolation between the two radiators when the two radiators operate independently when the difference between the resonance frequencies is within 200 MHz can be improved, thereby improving radiation performance of the two radiators.

In a possible implementation, a difference between the frequency of the resonance point of the first resonance and the frequency of the resonance point of the second resonance is less than or equal to 200 MHz. In other words, when the first radiator and the second radiator operate at a same frequency or adjacent frequencies, good isolation can be obtained, and both the two radiators can have good radiation performance.

In a possible implementation, communication frequency bands corresponding to the signal of the first operating frequency band and the signal of the second operating frequency band are between 2.3 GHz and 2.7 GHz.

In a possible implementation, the resonance point of the first resonance is within a range of 2.5 GHz to 2.7 GHz, and the resonance point of the second resonance is within a range of 2.4 GHz to 2.5 GHz. Alternatively, the resonance point of the first resonance is within a range of 2.4 GHz to 2.5 GHz, and the resonance point of the second resonance is within a range of 2.3 GHz to 2.4 GHz. Alternatively, the resonance point of the first resonance is within a range of 1710 MHz to 2170 MHz, and the resonance point of the second resonance is within a range of 1575 MHz to 1630 MHz. In other words, in the antenna apparatus provided in this application, the two radiators can obtain good isolation when operating independently in many adjacent frequency bands, and good radiation performance is obtained.

In a possible implementation, when the first radiator and the second radiator operate at the same time, the first radiator generates the first resonance, and the second radiator generates the second resonance. In other words, the first radiator and the second radiator may coexist and operate, that is, the first radiator can generate the first resonance when operating, and the second radiator can generate the second resonance when operating. In a coexistence state, there is good isolation between the first radiator and the second radiator, and good radiation performance is obtained.

It should be understood that the foregoing general descriptions and the following detailed descriptions are merely used as an example, and should not limit this application.

### BRIEF DESCRIPTION OF DRAWINGS

To describe technical solutions in embodiments of this application more clearly, the following briefly describes the accompanying drawings used in the embodiments. It is clear that the accompanying drawings in the following descriptions show merely some embodiments of this application, and a person of ordinary skill in the art may derive other drawings from these accompanying drawings without creative efforts.

FIG. 1 is a diagram of a structure of an electronic device according to an embodiment of this application;

FIG. 2 is a partial diagram of an electronic device according to an embodiment of this application;

FIG. 3 is a topology diagram of an electronic device according to a first embodiment of this application;

FIG. 4 is a partial enlarged diagram of positions of a first radiator and a second radiator in FIG. 3;

FIG. 5 is a diagram of a return loss curve and an isolation curve of an antenna apparatus according to a first embodiment of this application;

FIG. 6 is a partial diagram of an electronic device according to another embodiment of this application;

FIG. 7 is a topology diagram of an electronic device according to a second embodiment of this application;

FIG. 8 is a partial enlarged diagram of positions of a first radiator and a second radiator in FIG. 7;

FIG. 9 is a topology diagram of an electronic device according to a third embodiment of this application;

FIG. 10 is a partial enlarged diagram of positions of a first radiator and a second radiator in FIG. 9;

FIG. 11 is a partial enlarged diagram of an electronic device at positions of a first radiator and a second radiator according to a fourth embodiment of this application;

FIG. 12 is a diagram of a return loss curve of an antenna apparatus in a magnetoelectric coupling mode according to an embodiment of this application;

FIG. 13 is a diagram of an efficiency curve of an antenna apparatus in a magnetoelectric coupling mode according to an embodiment of this application;

FIG. 14 is a topology diagram of an electronic device according to a fifth embodiment of this application;

FIG. 15 is a partial enlarged diagram of positions of a first radiator and a second radiator in FIG. 14;

FIG. 16 is a diagram of a return loss curve of an antenna apparatus in an electronic device in an electrical parasitic mode according to a fifth embodiment of this application;

FIG. 17 is a comparison diagram of an efficiency curve of a first radiator in an antenna apparatus in an electrical parasitic mode and an efficiency curve of the first radiator in the antenna apparatus in a coexistence mode according to a fifth embodiment of this application;

FIG. 18 is a comparison diagram of an efficiency curve of a second radiator in an antenna apparatus in an electrical parasitic mode and an efficiency curve of the second radiator in the antenna apparatus in a coexistence mode according to a fifth embodiment of this application; and

FIG. 19 is a partial enlarged diagram of an electronic device at positions of a first radiator and a second radiator according to a sixth embodiment of this application.

### REFERENCE NUMERALS

100: first body;
110: first ground plane;
200: second body;
210: second ground plane;
300: display screen;
400: rotating shaft;
1: first radiator;
11: ground end;
12: first open end;
13: first feeding circuit;
14: first feeding point;
15: third tuning circuit;
2: second radiator;
21: first ground point;
22A: second open end;
22B: third open end;
23: second feeding circuit;
24: second feeding point;
25: ground point;
26: first tuning circuit;
27: second tuning circuit;
28: fourth tuning circuit.
3: parasitic stub; and
31: first gap.

### DESCRIPTION OF EMBODIMENTS

For ease of understanding technical solutions of this application, the following describes embodiments of this application in detail with reference to the accompanying drawings.

It should be noted that described embodiments are merely some rather than all of embodiments of this application. All other embodiments obtained by a person of ordinary skill in the art based on embodiments of this application without creative efforts shall fall within the protection scope of this application.

The terms used in embodiments of this application are merely for the purpose of illustrating specific embodiments, and are not intended to limit this application. The terms “a”, “the”, and “this” of singular forms used in embodiments and the appended claims of this application are also intended to include plural forms, unless otherwise specified in the context clearly.

It should be understood that the term “and/or” used in this specification describes only an association relationship between associated objects and represents that three relationships may exist. For example, A and/or B may represent the following three cases: Only A exists, both A and B exist, and only B exists. In addition, the character “/” in this specification generally indicates an “or” relationship between associated objects.

In descriptions of this application, unless otherwise specified and limited, the terms “first” and “second” are merely intended for a purpose of description, and should not be understood as an indication or implication of relative importance. Unless otherwise specified or stated, the term “a plurality of” means two or more than two. The terms “connection”, “fastening”, and the like should be understood in a broad sense. For example, the “connection” may be a fixed connection, a detachable connection, an integrated connection, or an electrical connection, or may be a direct connection, or an indirect connection through an intermediate medium. A person of ordinary skill in the art may understand specific meanings of the foregoing terms in this application based on specific cases.

Radiator or antenna stub: The radiator or antenna stub is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator via a feeder. The radiator converts the energy into specific polarized electromagnetic wave energy and radiates the energy in a required direction. A receive radiator converts specific polarized electromagnetic wave energy from a specific direction of space into modulated high-frequency current energy, and transmits the modulated high-frequency current energy to an input end of a receiver via a feeder.

The radiator (or antenna stub) may include a conductor having a specific shape and size, for example, a linear conductor or a sheet-like conductor. A specific shape is not limited in this application. In an embodiment, a linear radiator may be referred to as a linear antenna for short. In an embodiment, the linear radiator may be implemented by a conductive side frame, and may also be referred to as a side frame antenna. In an embodiment, the linear radiator may be implemented by a bracketed conductor, and may also be referred to as a bracketed antenna. In an embodiment, for the linear radiator or a radiator of the linear antenna, a conductor diameter (for example, including a thickness and a width) is much less than a wavelength (for example, a dielectric wavelength) (for example, the diameter is less than 1/16 of the wavelength), and a length may be comparable to the wavelength (for example, the dielectric wavelength) (for example, the length is approximately ⅛ of the wavelength, or is ⅛ to ¼ of the wavelength, or ¼ to ½ of the wavelength, or greater). Main forms of the linear antenna include a dipole antenna, a half-wave dipole antenna, a monopole antenna, a loop antenna, and an inverted F antenna (also referred to as Inverted F Antenna, IFA). For example, for the dipole antenna, each dipole antenna usually includes two radiation stubs, and each stub is fed by a feeding part from a feeding end of the radiation stub. For example, the inverted F antenna (IFA) may be considered as being obtained by adding a ground path to a monopole antenna. The IFA antenna has a feeding point and a ground point, and is referred to as the inverted F antenna because a side view of the IFA is in an inverted F shape. In an embodiment, a sheet-like radiator may include a microstrip antenna, or a patch antenna, for example, a planar inverted F antenna (also referred to as Planar Inverted F Antenna, PIFA). In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. The sheet-like radiator may be in a circular shape, a rectangular shape, a ring shape, or the like. A specific shape is not limited in this application. A structure of a microstrip antenna usually includes a dielectric substrate, a radiator, and a ground plane, where the dielectric substrate is disposed between the radiator and the ground plane.

The radiator (or antenna stub) may also include a slot or a gap formed on a conductor, for example, a closed or semi-closed slot or gap formed on a grounded conductor surface. In an embodiment, a radiator with a slot or a gap may be referred to as a slot antenna or a slotted antenna for short. In an embodiment, for the slot or the gap of the slot antenna/slotted antenna, a radial size (for example, including a width) is much less than a wavelength (for example, a dielectric wavelength) (for example, less than 1/16 of the wavelength), and a length size may be comparable to the wavelength (for example, the dielectric wavelength) (for example, the length is approximately ⅛ of the wavelength, or ⅛ to ¼ of the wavelength, or ¼ to ½ of the wavelength, or greater). In an embodiment, a radiator with a closed slot or gap may be referred to as a closed slot antenna for short. In an embodiment, a radiator with a semi-closed slot or gap (for example, an opening is additionally provided on the closed slot or gap) may be referred to as an open slot antenna for short. In some embodiments, the gap is long bar-shaped. In some embodiments, a length of the gap is approximately half the wavelength (for example, the dielectric wavelength). In some embodiments, the length of the gap is approximately an integer multiple of the wavelength (for example, a one-fold dielectric wavelength). In some embodiments, the gap may be used for feeding through a transmission line bridged on one side or two sides of the gap. In this way, a radio frequency electromagnetic field is excited on the gap, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced from the ground plane and is grounded at two ends of the radiator, to form a closed or semi-closed slot or gap. In an embodiment, the radiator of the slot antenna or the slotted antenna may be implemented by a bracketed conductor that is grounded at two ends, and may also be referred to as a bracketed antenna.

Coupling: Coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction of components; or may be understood as a form in which different components in a line structure are connected through a physical line that may transmit an electrical signal, for example, a copper foil or a conductive wire of a printed circuit board (PCB). The “indirect coupling” may be understood as electrical conduction of two conductors through air or without contact. In an embodiment, the indirect coupling may also be referred to as capacitive coupling. For example, signal transmission is implemented by forming an equivalent capacitor through coupling in a gap between two spaced conductive members.

Resonance frequency: The resonance frequency is also referred to as a resonant frequency. The resonance frequency may have a frequency range, that is, a frequency range in which a resonance occurs. The resonance frequency may be a frequency range in which a return loss is less than-6 dB. A strongest resonance point may be referred to as a resonance point, and a frequency corresponding to the resonance point is a center frequency or a point frequency. A return loss of the center frequency may be less than −20 dB. It should be understood that, unless otherwise specified, in a “first/second . . . resonance” generated by an antenna/a radiator in this application, the first resonance should be a fundamental mode resonance generated by the antenna/radiator, or a resonance with a lowest frequency generated by the antenna/radiator. It should be understood that the antenna/radiator may generate one or more antenna modes based on a specific design, and one fundamental mode resonance may be correspondingly generated in each antenna mode.

Resonance frequency band: A range of a resonance frequency is a resonance frequency band, and a return loss of any frequency in the resonance frequency band may be less than-6 dB or −5 dB.

Communication frequency band/Operating frequency band: Regardless of a type of antenna, the antenna constantly operates in a specific frequency range (a frequency bandwidth). For example, an operating frequency band of an antenna supporting a B40 frequency band includes a frequency in a range of 2300 MHz to 2400 MHz. In other words, the operating frequency band of the antenna includes the B40 frequency band. A frequency range that meets a specification requirement may be considered as an operating frequency band of an antenna. A width of the operating frequency band is referred to as an operating bandwidth. An operating bandwidth of an omnidirectional antenna may reach 3% to 5% of a center frequency. An operating bandwidth of a directional antenna may reach 5% to 10% of the center frequency. The bandwidth may be considered as a range of frequencies on two sides of the center frequency (for example, a resonance frequency of a dipole), where an antenna characteristic is within an acceptable value range of the center frequency.

The resonance frequency band and the operating frequency band may be the same, or may partially overlap. In an embodiment, one or more resonance frequency bands of an antenna may cover one or more operating frequency bands of the antenna.

Wavelength: A wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz. In this case, an operating wavelength may be a wavelength calculated based on the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in the air may be calculated as follows: (air wavelength or vacuum wavelength)=speed of light/frequency, where the frequency is a frequency (MHz) of the radiation signal, and the speed of light may be 3×108 m/s. A wavelength of the radiation signal in a dielectric may be calculated as follows: dielectric wavelength=(speed of light/\sqrt{ε})/frequency, where ε is a relative dielectric constant of the dielectric. The wavelength in some embodiments of this application is usually a dielectric wavelength, and may be a dielectric wavelength corresponding to the center frequency of the resonance frequency, or a dielectric wavelength corresponding to the center frequency of the operating frequency band supported by the antenna. For example, it is assumed that a center frequency of a B1 uplink frequency band (with a resonance frequency ranging from 1920 MHz to 1980 MHz) is 1955 MHz. In this case, a wavelength may be a dielectric wavelength calculated based on the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in some embodiments of this application may be simply calculated based on a relative dielectric constant of a dielectric filled in one or more sides of a radiator.

End/point: An “end/point” in a first end/second end/feeding end/ground end/feeding point/ground point/connection point of an antenna radiator cannot be understood in a narrow sense as an endpoint or an end part that is physically disconnected from another radiator, and may also be considered as a point or a section on a continuous radiator. In an embodiment, the “end/point” may include a connection/coupling region that is on the antenna radiator and that is coupled and connected to another conductive structure. For example, the feeding end/feeding point may be a coupling region that is on the antenna radiator and that is coupled and connected to a feeding structure (for example, a region opposite to a part of the feeding structure). For another example, the ground end/ground point may be a connection/coupling region that is on the antenna radiator and that is coupled and connected to the grounding structure.

Open end and ground end: In some embodiments, the open end and the ground end are, for example, relative to whether the open end and the ground end are grounded. The ground end is grounded, and the open end is not grounded. In some embodiments, the open end and the ground end are, for example, relative to another conductor. The ground end is electrically connected to the another conductor, and the open end is not electrically connected to the another conductor. In an embodiment, the open end may also be referred to as a floating end, a free end, an opening end or an open-circuit end. In an embodiment, the ground end may also be referred to as the ground end or a short-circuit end. It should be understood that, in some embodiments, another conductor may be coupled and connected through the open end, to transfer coupling energy (which may be understood as transferring a current).

A feeding circuit is a combination of all circuits configured to receive and transmit radio frequency signals. The feeding circuit may include a transceiver and a radio frequency front end (RF front end) circuit. In some cases, the “feeding circuit” is a radio frequency chip (RFIC, Radio Frequency Integrated Circuit) in a narrow sense, and the RFIC may be considered to include a radio frequency front end chip and the transceiver. The feeding circuit has a function of converting a radio wave (for example, a radio frequency signal) and an electrical signal (for example, a digital signal). Usually, the feeding circuit is considered as a part of radio frequency.

In some embodiments, an electronic device may further include a test base (which is also referred to as a radio frequency base or a radio frequency test base). A coaxial cable may be inserted into the test base, to test a characteristic of a radio frequency front end circuit or the radiator of the antenna through the cable. The radio frequency front end circuit may be considered as a circuit part coupled between the test base and the transceiver.

In some embodiments, the radio frequency front end circuit may be integrated into the radio frequency front end chip of the electronic device, or the radio frequency front end circuit and the transceiver may be integrated into the radio frequency chip of the electronic device.

It should be understood that any two of a first feeding circuit, a second feeding circuit, . . . , and an N^{th} feeding circuit in this application may share a same transceiver, for example, transmit a signal through a radio frequency channel in the transceiver (for example, a pin of the radio frequency chip); and may further share a radio frequency front end circuit, for example, process the signal via a switch or an amplifier in the radio frequency front end.

It should be further understood that two of the first feeding circuit, the second feeding circuit, . . . , and the N^{th} feeding circuit in this application usually correspond to two radio frequency test bases of the electronic device.

A tuning circuit is a circuit related to adjustment of a resonance frequency of an antenna. In an embodiment, the tuning circuit is coupled between the radiator and the ground plane. In an embodiment, the tuning circuit is coupled between the feeding circuit and the radiator. In an embodiment, the tuning circuit has a function of impedance matching and/or frequency tuning. Usually, the tuning circuit is considered as a part of an antenna.

In an embodiment, the tuning circuit may include a switch and/or an electronic element/device, and the switch may be an electronic element/device configured to switch a coupling connection of the radiator. The switch in the tuning circuit may also be referred to as an antenna switch.

Ground/Ground plane: A ground/ground plane may generally represent at least a part of any grounding plane, or grounding plate, or grounding metal layer of an electronic device (for example, a mobile phone), or at least a part of any combination of any grounding plane, grounding plate, grounding part, or the like. The “ground/ground plane” may be configured to ground a component of the electronic device. In an embodiment, the “ground/ground plane” may include any one or more of the following: a grounding plane of a circuit board of the electronic device, a grounding plate formed in a middle frame of the electronic device, a grounding metal layer formed by a metal film under a screen, a conductive grounding plane of a battery, and a conductive member or a metal member electrically connected to the grounding layer/grounding plate/metal layer. In an embodiment, the circuit board may be a printed circuit board (PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a grounding plane, and a trace layer. The trace layer and the grounding plane are electrically connected through a via. In an embodiment, components such as a display, a touchscreen, an input button, a transmitter, a processor, a memory, a battery, a charging circuit, and a system-on-chip (SoC) structure may be mounted on or connected to the circuit board, or electrically connected to the trace layer and/or the grounding plane in the circuit board. For example, a radio frequency source is disposed on the trace layer.

Any of the foregoing grounding plane, or grounding plate, or grounding metal layer is made of a conductive material. In an embodiment, the conductive material may be any one of the following materials: copper, aluminum, stainless steel, brass and an alloy thereof, copper foil on an insulation substrate, aluminum foil on the insulation substrate, gold foil on the insulation substrate, silver-plated copper, silver-plated copper foil on the insulation substrate, silver foil on the insulation substrate, tin-plated copper, cloth impregnated with graphite powder, a graphite-coated substrate, a copper-plated substrate, a brass-plated substrate, and an aluminum-plated substrate. A person skilled in the art may understand that the grounding plane/grounding plate/grounding metal layer may alternatively be made of another conductive material.

Grounding: Grounding means coupling to the ground/ground plane via a grounding structure and/or a grounding circuit. In an embodiment, grounding may be grounding via an entity, for example, grounding via an entity (or referred to as entity grounding) at a specific position on a side frame is implemented via some mechanical members of a middle frame. In an embodiment, grounding may be grounding via a component, for example, grounding via a component (or referred to as component grounding) like a capacitor/inductor/resistor connected in series or in parallel.

In a product design of a foldable terminal, antennas are arranged on two sides of a rotating shaft in some models. When the mobile phone is in a folded state, the antennas on the two sides of the rotating shaft are close to each other. As a result, when the two antennas operate independently, isolation deteriorates, and antenna performance deteriorates. To reduce the impact of isolation, the two antennas need to operate at low frequency and medium-high frequency, and cannot operate at the same frequency or with a small frequency difference.

Antenna system efficiency: Antenna system efficiency is a ratio of power radiated by an antenna to space (that is, power of an electromagnetic wave part that is effectively converted) to input power of the antenna. The system efficiency is actual efficiency obtained by matching an antenna port. In other words, the system efficiency of the antenna is actual efficiency (namely, efficiency) of the antenna.

Antenna radiation efficiency: The antenna radiation efficiency is a ratio of power radiated through an antenna into space (that is, power effectively converted into an electromagnetic wave) to active power input to the antenna. Herein, active power input to the antenna=input power of the antenna-loss power. The loss power mainly includes return loss power and metal ohmic loss power and/or dielectric loss power. The radiation efficiency is a value for measuring a radiation capability of the antenna. Both a metal loss and a dielectric loss are factors that affect the radiation efficiency.

A person skilled in the art may understand that efficiency is usually indicated by a percentage, and there is a corresponding conversion relationship between the efficiency and dB. Efficiency closer to 0 dB indicates better efficiency of the antenna.

Antenna return loss: An antenna return loss may be understood as a ratio of power of a signal reflected back to an antenna port through an antenna circuit to transmit power of the antenna port. A smaller reflected signal indicates a larger signal radiated by an antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of S parameters. S11 indicates a reflection coefficient, and the parameter can indicate quality of transmit efficiency of the antenna.

In an embodiment, an S11 diagram may be understood as a diagram of resonance generated by the antenna. In an embodiment, a part that is of the resonance shown in the S11 diagram and that is less than −6 dB may be understood as a resonance frequency/a frequency range/an operating frequency band generated by the antenna. The S11 parameter is usually a negative number. A smaller S11 parameter indicates a smaller antenna return loss, less energy reflected back by the antenna, namely, more energy that actually enters the antenna, and higher system efficiency of the antenna. A larger S11 parameter indicates a larger antenna return loss and lower system efficiency of the antenna.

It should be noted that an S11 value of −6 dB is usually used as a standard in engineering. When an S11 value of the antenna is less than −6 dB, it may be considered that the antenna can operate normally, or it may be considered that transmit efficiency of the antenna is high.

Antenna isolation: Antenna isolation is a ratio of a signal that is transmitted by an antenna and received by another antenna to a signal of the transmit antenna. The isolation is a physical quantity for measuring a degree of mutual coupling between antennas. If two antennas form a dual-port network, isolation between the two antennas is S21 and S12 for the antennas. The antenna isolation may be indicated by parameters S21 and S12. The parameters S21 and S12 are usually negative numbers. Smaller parameters S21 and S12 indicate higher isolation between the antennas and a lower degree of mutual coupling between the antennas. Larger parameters S21 and S12 indicate lower isolation between the antennas and a higher degree of mutual coupling between the antennas. The isolation between the antennas depends on an antenna radiation pattern, a spatial distance between the antennas, an antenna gain, and the like.

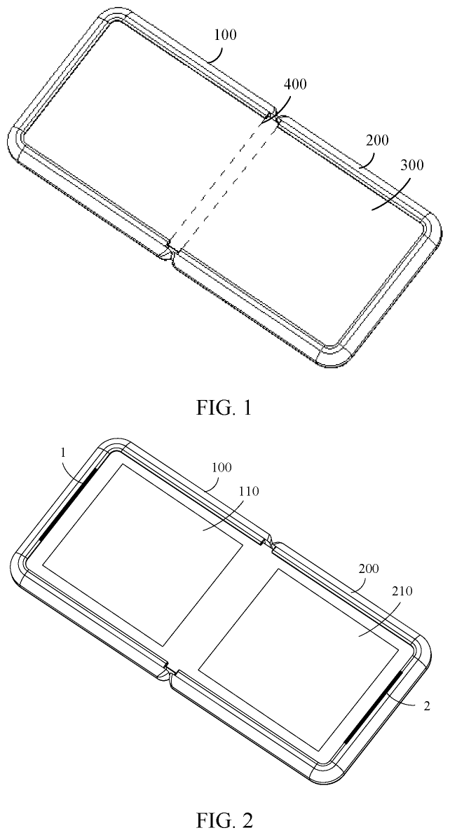

The technical solutions provided in some embodiments of this application are applicable to an electronic device that uses one or more of the following communication technologies: a Bluetooth (BT) communication technology, a global positioning system (GPS) communication technology, a wireless fidelity (Wi-Fi) communication technology, a global system for mobile communications (GSM) communication technology, a wideband code division multiple access (WCDMA) communication technology, a long term evolution (LTE) communication technology, a 5G communication technology, and other future communication technologies. The electronic device in some embodiments of this application may be a foldable electronic device, for example, a foldable mobile phone, a foldable tablet computer, or a foldable smart home. This is not limited in embodiments of this application. FIG. 1 shows an example of an electronic device provided in an embodiment of this application. An example in which the electronic device is a foldable mobile phone is used for description.

Refer to FIG. 1. The electronic device includes a first body 100, a second body 200, and a rotating shaft 400. The first body 100 and the second body 200 are respectively disposed on two sides of the rotating shaft 400, and are rotatively connected to the rotating shaft 400. FIG. 2 is a partial diagram of an electronic device according to an embodiment of this application. Refer to FIG. 2. The first body 100 includes a first ground plane 110, and the second body 200 includes a second ground plane 210. The first ground plane 110 and the second ground plane 210 may be printed circuit boards. The first ground plane 110 and the second ground plane 210 may be configured to mount and support various components, and provide an electrical connection function. The first body 100, the second body 200, and the rotating shaft 400 may form a foldable electronic device such as a foldable mobile phone or a foldable tablet computer. These devices include a display screen 300. The display screen 300 may cover the first body 100, the second body 200, and the rotating shaft 400, and is configured to display. In an embodiment, both the first body 100 and the second body 200 may include a metal middle frame, a metal side frame, or the like of the electronic device, or may be used as a housing member of the electronic device. In an embodiment, the electronic device provided in this embodiment further includes an antenna apparatus. A first radiator 1 in the antenna apparatus may be disposed on the first body 100, and a second radiator 2 in the antenna apparatus is disposed on the second body 200. When the electronic device is in an unfolded state or a folded state, the two radiators may operate as two independent antennas. Certainly, when the electronic device is in the folded state, one of the two radiators may be used as a parasitic stub 3 of the other, so that the two radiators form one antenna to operate.

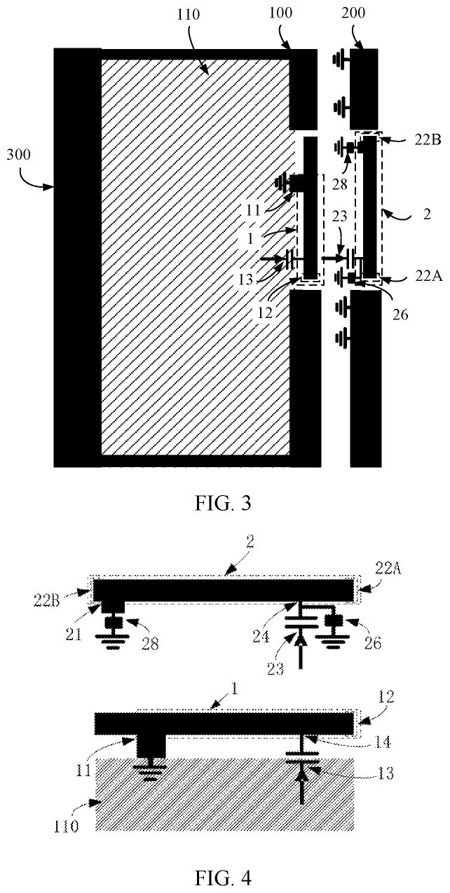

In an embodiment, FIG. 3 is a topology diagram of an electronic device according to an embodiment of this application. Refer to FIG. 3. The antenna apparatus includes the first radiator 1, a first feeding circuit 13, the second radiator 2, and a second feeding circuit 23. The first radiator 1 may be disposed on the first body 100, and can move synchronously with the first body 100. FIG. 4 is a partial enlarged diagram of positions of the first radiator 1 and the second radiator 2 in FIG. 3. Refer to FIG. 4. The first radiator 1 is provided with a ground end 11 and a first open end 12, where the ground end 11 is coupled to the first ground plane 110 for grounding. In an embodiment, the ground end 11 may be directly connected to the first ground plane 110. In an embodiment, the ground end 11 may alternatively be indirectly connected to the first ground plane 110 by using a component such as a capacitor, an inductor, or a radio frequency switch. In an embodiment, the ground end 11, the first radiator 1, and at least a part of the first ground plane 110 may be integrally formed, so that grounding (compared with component grounding) is implemented through a simplified process. In an embodiment, a middle frame of an electronic device such as a mobile phone may be of an integrated structure, and some parts of the middle frame may be reused as the first radiator 1, the ground end 11, and the first ground plane 110 in this application. In an embodiment, the first ground plane 110 may be a middle plate part of the middle frame in the electronic device such as the mobile phone.

The first open end 12 is not in contact with the first ground plane 110. The first radiator 1 includes a first feeding point 14; and the first feeding circuit 13 is coupled to the first radiator 1 through the first feeding point 14, and is configured to feed a signal of a first operating frequency band to the first radiator 1. The first radiator 1 is configured to generate a first resonance corresponding to the first operating frequency band.

The second radiator 2 may be disposed on the second body 200, and can move synchronously with the second body 200. Refer to FIG. 4. The second radiator 2 is provided with a first ground point 21, a second open end 22A, and a third open end 22B. The first ground point 21 is located between the second open end 22A and the third open end 22B, and the first ground point 21 is coupled to the second ground plane 210 for grounding. The first ground point 21 may be directly connected to the second ground plane 210, or may be indirectly connected to the second ground plane 210 through a component. Neither the second open end 22A nor the third open end 22B is in contact with the second ground plane 210. The second radiator 2 includes a second feeding point 24. The second feeding circuit 23 is coupled to the second radiator 2 through the second feeding point 24, and is configured to feed a signal of a second operating frequency band to the second radiator 2. The second radiator 2 is configured to generate a second resonance corresponding to the second operating frequency band, and the second operating frequency band is the same as or adjacent to the first operating frequency band. In an embodiment, a frequency of a resonance point of the first resonance is higher than a frequency of a resonance point of the second resonance.

In an embodiment, as described above, both the first body 100 and the second body 200 may include the metal middle frame, the metal side frame, or the like of the electronic device, and the first radiator 1 and the second radiator 2 may reuse a side frame of the electronic device. In other words, a part of the side frame of the electronic device may be used as the first radiator 1 and the second radiator 2, so that space occupied by the radiator in the electronic device can be reduced, thereby facilitating a miniaturization design of the electronic device. In another embodiment, both the first body 100 and the second body 200 include a housing. The housing may be a plastic housing or a metal housing, or a housing formed by disposing a metal layer in a plastic housing. Both the first radiator 1 and the second radiator 2 may be disposed in the housing. When internal space of the electronic device is large enough, the antenna apparatus may be entirely mounted inside the housing, to facilitate disassembly, assembly, and maintenance of the antenna apparatus.

When the electronic device is in the unfolded state, the first radiator 1 and the second radiator 2 are far away from each other, so that isolation is good, and the first radiator 1 and the second radiator 2 can operate independently and normally. When the electronic device is in the folded state, the first body 100 and the second body 200 are opposite to each other, and the first radiator 1 and the second radiator 2 are close to each other. If the first radiator 1 and the second radiator 2 have a same structure and a same size specification, for example, electrical lengths of the two radiators are both 1/4λ, where λ is a wavelength. When the two antennas operate on a same frequency or adjacent frequencies, isolation between the two antennas is poor, and radiation performance of the radiators is poor. Consequently, the two antennas cannot operate normally and independently in the folded state of the electronic device. In this case, to improve isolation between the two radiators as much as possible and meet radiation performance when the two radiators operate independently, the two radiators usually operate in different frequency bands with a large frequency difference. For example, one radiator operates in a low frequency band, and the other radiator operates in a medium-high frequency band. This imposes a large limitation on an operating frequency band of the antenna.

Therefore, in an embodiment, refer to FIG. 4. The antenna apparatus further includes a first tuning circuit 26, and one end of the first tuning circuit 26 may be coupled to the second radiator 2. In an embodiment, one end of the first tuning circuit 26 may be coupled to a position that is on the second radiator 2 and that is close to the second feeding point 24. In an embodiment, one end of the first tuning circuit 26 may be coupled to the second feeding point 24, for example, the first tuning circuit 26 is electrically connected to the second radiator 2 by sharing a spring (usually referred to as a feeding spring). The other end of the first tuning circuit 26 is coupled to the second ground plane 210. The first tuning circuit 26 is configured to adjust the second resonance generated by the second radiator 2 to the second operating frequency band that is the same as or adjacent to the first operating frequency band, so that the first radiator 1 and the second radiator 2 operate on a same frequency or adjacent frequencies. A ratio of a length of the second radiator 2 between the third open end 22B and the second open end 22A to a length of the first radiator 1 between the ground end 11 and the first open end 12 is greater than 1 and less than or equal to 2. When the electronic device is in the folded state, projections of the first open end 12 and the second open end 22A at least partially overlap in a thickness direction of the electronic device, and a projection of the ground end 11 is located between a projection of the third open end 22B and the projection of the second open end 22A. “Located between the projection of the third open end 22B and the projection of the second open end 22A” should be understood as that the projection of the ground end 11 does not overlap the projection of the third open end 22B or the projection of the second open end 22A. When the first feeding circuit 13 feeds the first radiator 1 through the first feeding point 14, and the second feeding circuit 23 feeds the second radiator 2 through the second feeding point 24, electric field strong points can be formed at both the first open end 12 and the second open end 22A. In addition, because the projections of the first open end 12 and the second open end 22A at least partially overlap in the thickness direction of the electronic device, the electric field strong point at the first open end 12 and the electric field strong point at the second open end 22A can be coupled to each other, and a first current path is generated. In addition, the ground end 11 of the first radiator 1 and the first ground point 21 of the second radiator 2 are respectively current strong points. The current strong points of the two radiators may be coupled to form a second current path. Directions of the first current path and the second current path are reverse to each other. Therefore, when the first current path and the second current path meet a phase cancellation condition, isolation between the two radiators is good when the two radiators operate in a same frequency band or adjacent frequency bands, so that the two radiators can operate independently and normally in the folded state of the electronic device. The first tuning circuit 26 may include a capacitor or an inductor, or may be formed by combining a capacitor and an inductor, or include a radio frequency switch. The radio frequency switch has a plurality of branches, and each branch may be connected to a capacitor or an inductor. The first tuning circuit 26 may adjust the resonance frequency of the second radiator 2, so that the resonance frequency of the second radiator 2 is increased, and the resonance frequency of the second radiator 2 is the same as or adjacent to the resonance frequency of the first radiator 1.

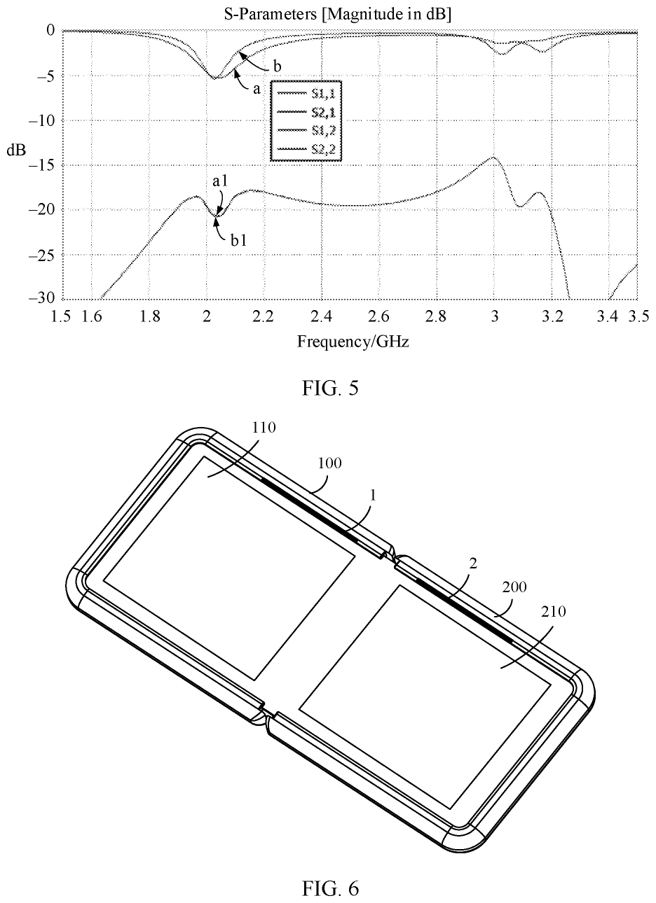

FIG. 5 is a diagram of a return loss curve and an isolation curve of an antenna apparatus according to a first embodiment of this application. Refer to FIG. 5. A curve a1 is a return loss curve of the first radiator 1, a curve a2 is an isolation curve of the first radiator 1, a curve b1 is a return loss curve of the second radiator 2, and a curve b2 is an isolation curve of the second radiator 2. It can be seen from the curves a1 and b1 that the first radiator 1 and the second radiator 2 operate in a same resonance frequency band (near 2.04 GHz). It can be seen from the curves a2 and b2 that the curve a2 and the curve b2 almost overlap, and isolation less than −15 dB is good. Therefore, according to the antenna apparatus provided in this embodiment of this application, in the folded state of the electronic device, isolation between the first radiator 1 and the second radiator 2 is good when the first radiator 1 and the second radiator 2 operate independently. In an embodiment, refer to FIG. 2. The first radiator 1 is disposed on a side that is of the first body 100 and that is away from the rotating shaft 400, and the second radiator 2 is disposed on a side that is of the second body 200 and that is away from the rotating shaft 400. When the electronic device is in a flattened state, there is a large distance between the first radiator 1 and the second radiator 2, so that isolation between the first radiator 1 and the second radiator 2 is good when the first radiator 1 and the second radiator 2 operate independently. When the electronic device is in the folded state, the first radiator 1 and the second radiator 2 are close, and the path formed by coupling the electric field strong points of the two radiators and another current path formed by coupling the current strong points of the two radiators cancel each other, so that isolation between the two radiators is good when the two radiators operate independently.

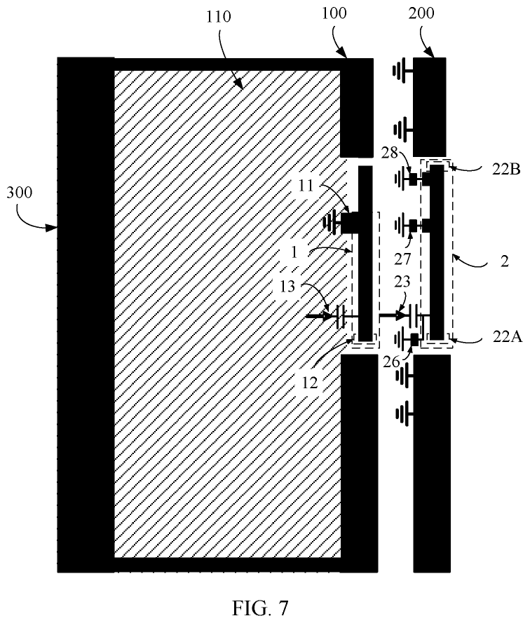

In another embodiment, FIG. 6 is a partial diagram of an electronic device according to another embodiment of this application. Refer to FIG. 6. The first radiator 1 is disposed on a side that is of the first body 100 and that is adjacent to the rotating shaft 400, and the second radiator 2 is disposed on a side that is of the second body 200 and that is adjacent to the rotating shaft 400. In an axial direction of the rotating shaft 400, both the first radiator 1 and the second radiator 2 are located on a same side of the electronic device. When the electronic device is in the flattened state, there can also be a large distance between the first radiator 1 and the second radiator 2, so that isolation between the first radiator 1 and the second radiator 2 is good when the first radiator 1 and the second radiator 2 operate independently. When the electronic device is in the folded state, the first radiator 1 and the second radiator 2 are close, and the path formed by coupling the electric field strong points of the two radiators and the another current path formed by coupling the current strong points of the two radiators cancel each other, so that isolation between the two radiators is good when the two radiators operate independently.

In an embodiment, refer to FIG. 4. A distance between the first feeding point 14 and the first open end 12 may be less than 7.5 mm, and a distance between the second feeding point 24 and the second open end 22A may also be less than 7.5 mm. In this way, the first feeding point 14 may be closer to the first open end 12, and the second feeding point 24 may be closer to the second open end 22A, so that the first radiator 1 forms an electric field strong point at the first open end 12, and the second radiator 2 forms an electric field strong point at the second open end 22A. When the electronic device is in the folded state, the electric field strong point of the first radiator 1 and the electric field strong point of the second radiator 2 can be coupled to each other to form a current path, so that the current path can cancel another current path formed by coupling ground ends of the two radiators, thereby improving isolation between the two radiators when the two radiators operate independently. In a possible implementation, an electrical length between the first feeding point 14 and the first open end 12 is less than 1/8λ, where λ is a wavelength corresponding to the range of the first operating frequency band. An electrical length between the second feeding point 24 and the second open end 22A is less than 1/8λ, where λ is a wavelength corresponding to the range of the second operating frequency band. In this way, the first feeding point 14 may also be closer to the first open end 12, and the second feeding point 24 may also be closer to the second open end 22A. Details are not described herein again.

In an embodiment, when the first radiator 1 and the second radiator 2 operate in a same frequency band, the frequency band may be a communication frequency band between 2.3 GHz and 2.7 GHz. When the first radiator 1 and the second radiator 2 operate in adjacent frequency bands, a minimum difference between a frequency of a signal in the first operating frequency band and a frequency of a signal in the second operating frequency band is greater than 0 and less than or equal to 200 MHz. In other words, a difference between a minimum value of the first operating frequency band and a maximum value of the second operating frequency band is less than or equal to 200 MHz. In an embodiment, a difference between the frequency of the resonance point of the first resonance and the frequency of the resonance point of the second resonance is less than or equal to 200 MHz In an embodiment, the resonance point of the first resonance is within a range of 2.5 GHz to 2.7 GHz (cellular B 41 frequency band), and the resonance point of the second resonance is within a range of 2.4 GHz to 2.5 GHz (Wi-Fi 2.4G). Alternatively, the resonance point of the first resonance is within a range of 2.4 GHz to 2.5 GHz (Wi-Fi 2.4G), and the resonance point of the second resonance is within a range of 2.3 GHz to 2.4 GHz (cellular B40 frequency band). Alternatively, the resonance point of the first resonance is within a range of 1710 MHz to 2170 MHz (cellular B3 frequency band), and the resonance point of the second resonance is within a range of 1575 MHz to 1630 MHz (GPS).

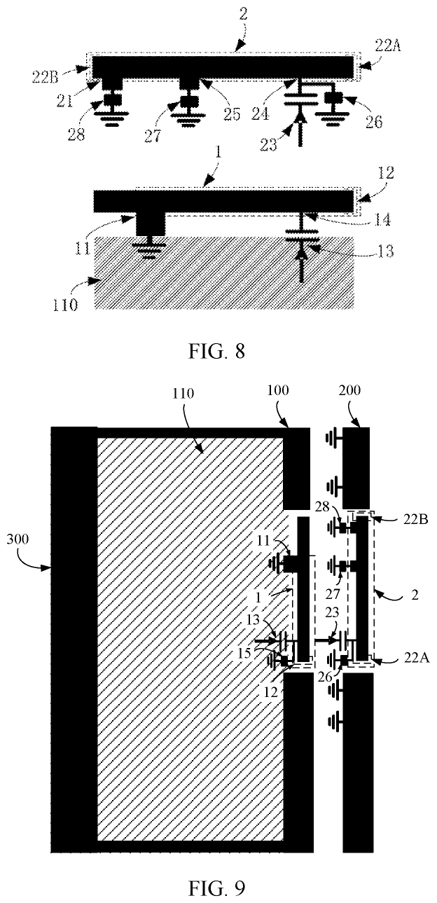

In an embodiment, because the length of the second radiator 2 between the third open end 22B and the second open end 22A is greater than the length of the first radiator 1 between the ground end 11 and the first open end 12, when a component is not used to adjust a frequency, the resonance frequency of the second radiator 2 with a long length is lower than the resonance frequency of the first radiator 1 with a short length. FIG. 7 is a topological diagram of an electronic device according to a second embodiment of this application. FIG. 8 is a partial enlarged diagram of positions of the first radiator 1 and the second radiator 2 in FIG. 7. Refer to FIG. 8. To implement co-frequency operation of the first radiator 1 and the second radiator 2, the second radiator 2 includes a second ground point 25, and the second ground point 25 is disposed between the first ground point 21 and the second feeding point 24. The second ground point 25 is a position that is on the second radiator 2 and that is used for grounding. The antenna apparatus further includes a second tuning circuit 27, where one end of the second tuning circuit 27 is connected to the second ground point 25, and the other end is connected to the second ground plane 210 for grounding. The second tuning circuit 27 may include a capacitor or an inductor, or may be formed by combining a capacitor and an inductor, or include a radio frequency switch. The radio frequency switch has a plurality of branches, and each branch may be connected to a capacitor or an inductor. The second tuning circuit 27 may adjust an efficiency dip of the second radiator 2, so that the efficiency dip of the second radiator 2 becomes shallow or moves out of a band, so that the two radiators have high isolation, and the two radiators can obtain good antenna performance.

In an embodiment, when the electronic device is in the folded state, in the thickness direction of the electronic device, the projection of the ground end 11 is at least partially located between a projection of the first ground point 21 and a projection of the second ground point 25. In an embodiment, the projection of the ground end 11 may be completely located between the projection of the first ground point 21 and the projection of the second ground point 25, and does not overlap the projection of the first ground point 21 and the projection of the second ground point 25. In another embodiment, at least a part of the projection of the ground end 11 may overlap the projection of the first ground point 21 and/or the projection of the second ground point 25. The ground end 11, the first ground point 21, and the second ground point 25 are staggered from each other, so that ground return paths of the ground end 11 and the first ground point 21 are different. This helps improve isolation between the first radiator 1 and the second radiator 2 during operation. In addition, the ground return paths of the ground end 11 and the second ground point 25 are different, which helps adjust a frequency by using the second tuning circuit 27 connected to the second ground point 25, so that current paths of the first radiator 1 and the second radiator 2 meet a phase cancellation condition, and better isolation can be obtained when the first radiator 1 and the second radiator 2 each operate independently in the folded state of the electronic device.

In an embodiment, an electrical length of the first radiator 1 between the ground end 11 and the first open end 12 is 1/4λ, where λ is a wavelength corresponding to a range of the first operating frequency band. The first radiator 1 having the electrical length can not only obtain good signal receiving and sending quality, but also have a small structure size, thereby facilitating a miniaturization design of the antenna apparatus.

In an embodiment, an electrical length of the second radiator 2 between the third open end 22B and the second open end 22A is between 1/4λ and 1/2λ, where λ is a wavelength corresponding to a range of the second operating frequency band. The second radiator 2 has a larger electrical length than the first radiator 1, which helps improve isolation between the first radiator 1 and the second radiator 2 when the first radiator and the second radiator operate independently, and can ensure that the second radiator 2 obtains good signal receiving and sending quality, thereby facilitating structure miniaturization.

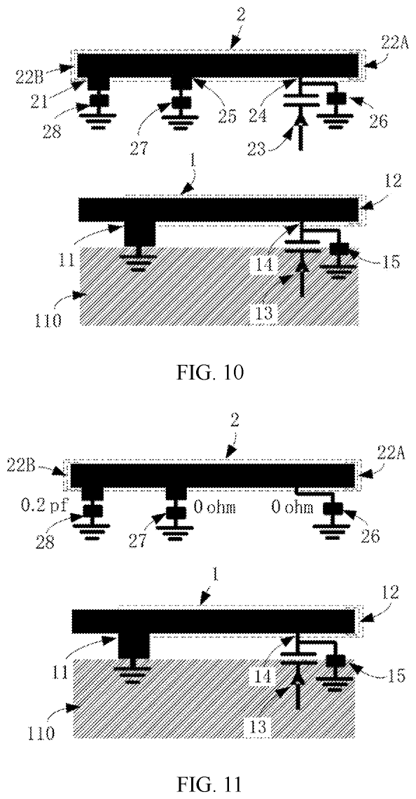

In an embodiment, FIG. 9 is a topology diagram of an electronic device according to a third embodiment of this application. FIG. 10 is a partial enlarged diagram of positions of the first radiator 1 and the second radiator 2 in FIG. 9. Refer to FIG. 10. The antenna apparatus further includes a third tuning circuit 15, and one end of the third tuning circuit 15 is connected to the first radiator 1. In an embodiment, the one end of the third tuning circuit 15 may be coupled to a position that is on the first radiator 1 and that is close to the first feeding point 14. In an embodiment, the one end of the third tuning circuit 15 may be coupled to the first feeding point 14. The other end of the third tuning circuit 15 is connected to the first ground plane 110. In other words, the first radiator 1 is grounded at the first feeding point 14 through the third tuning circuit 15. The third tuning circuit 15 and the foregoing first tuning circuit 26 may have a similar structure. In other words, the third tuning circuit 15 may also include a capacitor or an inductor, or may be formed by a combination of a capacitor and an inductor, or include a radio frequency switch. The radio frequency switch has a plurality of branches, and a capacitor or an inductor may be connected to each branch. The third tuning circuit 15 may adjust the resonance frequency of the first radiator 1 to correspond to the first operating frequency band. In addition, in some other embodiments, the third tuning circuit 15 may not be configured. This is not limited in this embodiment.

In an embodiment, the third tuning circuit 15 may be configured for the first radiator 1, and the first tuning circuit 26 may be configured for the second radiator 2. The first tuning circuit 26 and the third tuning circuit 15 may be jointly adjusted, so that resonance frequencies of the first radiator 1 and the second radiator 2 are the same or adjacent. This facilitates adjustment of the resonance frequencies, implements independent operation of the first radiator 1 and the second radiator 2 in a same frequency or adjacent frequencies, and achieves high isolation.

In an embodiment, for the first radiator 1 and the second radiator 2 that form a cellular antenna, the cellular antenna may support B1, B3, and B7 frequency bands. To facilitate adjustment of an operating frequency, the first tuning circuit 26, the second tuning circuit 27, and the third tuning circuit 15 each may include an adjustable component such as a radio frequency switch. In an adjustment process, the first resonance of the first radiator 1 may be first adjusted to correspond to the first operating frequency band through the third tuning circuit 15, and then the second tuning circuit 27 connected to the second ground point 25 on the second radiator 2 may be adjusted. The efficiency dip of the second radiator 2 may be adjusted through the second tuning circuit 27, so that the efficiency dip of the second radiator 2 becomes shallow or moves out of a band, so that the second radiator 2 and the first radiator 1 have good isolation. Then, the first tuning circuit 26 is adjusted, so that the second resonance of the second radiator 2 is located in the corresponding second operating frequency band. The second operating frequency band is the same as or adjacent to the first operating frequency band, so that isolation between the first radiator 1 and the second radiator 2 is good when the first radiator 1 and the second radiator 2 operate independently at a same frequency or adjacent frequencies, and good antenna performance can be obtained.

In an embodiment, the first tuning circuit 26 may include a first inductor, and the third tuning circuit 15 may include a second inductor. To be specific, the first inductor is connected in parallel at the first feeding point 14, and the second inductor is connected in parallel at the second feeding point 24. An inductance value of the first inductor is less than an inductance value of the second inductor, so that the resonance frequencies of the first radiator 1 and the second radiator 2 can be adjusted to a same frequency or adjacent frequencies, to implement intra-frequency or adjacent-frequency operation of the first radiator 1 and the second radiator 2. In an embodiment, the third tuning circuit 15 may not be connected at the first feeding point 14, that is, a tuning component such as a capacitor or an inductor is not connected, and only the second inductor is connected in parallel at the second feeding point 24. By using a frequency modulation function of the second inductor, the resonance frequency of the second radiator 2 may also be adjusted to be the same as or adjacent to the resonance frequency of the first radiator 1, so that the first radiator 1 and the second radiator 2 operate in a same frequency band.

In an embodiment, refer to FIG. 10. The antenna apparatus further includes a fourth tuning circuit 28. One end of the fourth tuning circuit 28 is connected to the first ground point 21, and the other end is connected to the second ground plane 210. In other words, the second radiator 2 is grounded at the first ground point 21 through the fourth tuning circuit 28. The fourth tuning circuit 28 may also include a capacitor or an inductor, or may be formed by combining a capacitor and an inductor, or include a radio frequency switch. The radio frequency switch has a plurality of branches, and each branch may be connected to a capacitor or an inductor. The fourth tuning circuit 28 helps adjust an efficiency dip of the second radiator 2, so that the second radiator 2 and the first radiator 1 have good isolation. In a possible implementation, the fourth tuning circuit 28 may cooperate with the second tuning circuit 27 to perform adjustment, which helps improve adjustment precision of the efficiency dip, and can better match isolation between the first radiator 1 and the second radiator 2. Certainly, as described above, the first ground point 21 of the second radiator 2 may also be directly connected to the second ground plane 210, and does not need to be connected to a tuning device such as a capacitor or an inductor. Details are not described herein again. In some other embodiments, the antenna apparatus may further include a fifth tuning circuit (not shown in the figure). One end of the fifth tuning circuit is connected to the ground end 11, and the other end is connected to the first ground plane 110, so that the first radiator 1 is indirectly grounded through the fifth tuning circuit. A function of the fifth tuning circuit is similar to a function of the third tuning circuit 15, and both may be used to adjust the resonance frequency of the first radiator 1 to correspond to the first operating frequency band.

In an embodiment, FIG. 11 is a partial enlarged diagram of an electronic device at positions of the first radiator 1 and the second radiator 2 according to a fourth embodiment of this application. Refer to FIG. 11. The second radiator 2 is connected to the first tuning circuit 26 at the second feeding point 24, the second radiator 2 is connected to the second tuning circuit 27 at the second ground point 25, and the first radiator 1 is connected to the fourth tuning circuit 28 at the first ground point 21. In an embodiment, both the first tuning circuit 26 and the second tuning circuit 27 may include an adjustable component such as a radio frequency switch, and the fourth tuning circuit 28 may be a capacitor. When the electronic device is in the folded state, the radio frequency switch connected to the second open end 22A and the second ground point 25 may be adjusted to 0 ohms. In this case, the second radiator 2 is in an abnormal operating state, and the first radiator 1 is in a normal operating state. In this state, the second radiator 2 may be used as a parasitic stub 3 of the first radiator 1, to enhance radiation performance of the first radiator 1. Specifically, for the second radiator 2 that does not operate normally, because the first tuning circuit 26 of the second radiator 2 is adjusted to 0 ohms, a current strong point is formed at the second open end 22A of the second radiator 2, and an electric field strong point is formed at the first ground point 21. For the first radiator 1 that operates normally, the first open end 12 is an electric field strong point, and the ground end 11 is a current strong point. Therefore, in the folded state of the electronic device, the electric field strong point of the first open end 12 of the first radiator 1 is coupled to the current strong point of the second open end 22A of the second radiator 2, and the current strong point of the ground end 11 of the first radiator 1 is coupled to the electric field strong point of the first ground point 21 of the second radiator 2. Therefore, the first radiator 1 and the second radiator 2 form a magnetoelectric coupling mode, that is, a magnetic parasitic mode. The second radiator 2 is used as the parasitic stub 3 of the first radiator 1, so that the first radiator 1 and the second radiator 2 jointly form an antenna. Radiation performance of the first radiator 1 can be improved through the second radiator 2. In this embodiment, when the electronic device is used in the folded state, when the second radiator 2 is not used and only the first radiator 1 is used, the second radiator 2 may be switched to the parasitic stub 3 of the first radiator 1, to improve radiation performance of the first radiator 1, so that the first radiator 1 can also play good radiation performance in the folded state of the electronic device.

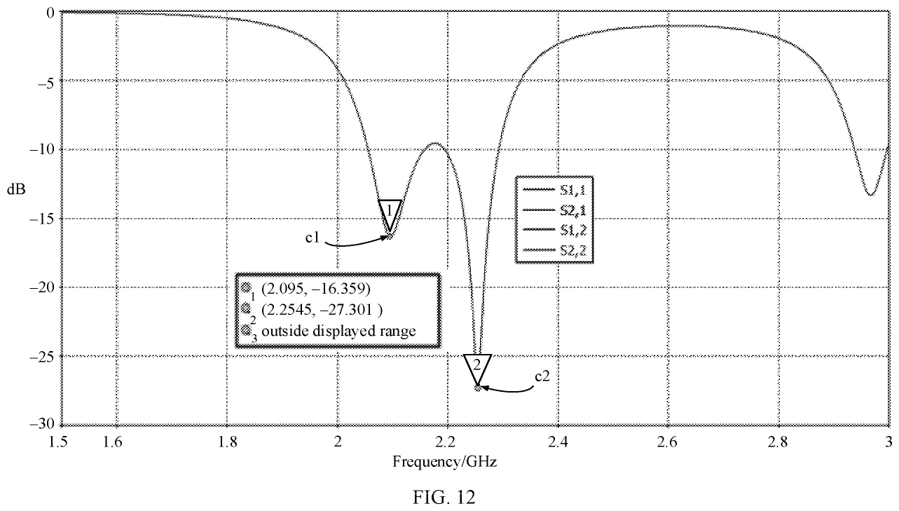

FIG. 12 is a diagram of a return loss curve of an antenna apparatus in a magnetoelectric coupling mode according to an embodiment of this application. A horizontal coordinate is a frequency, and a vertical coordinate is a return loss. Refer to FIG. 12. Two resonance points c1 and c2 are generated in a frequency band of 2 GHz to 2.4 GHz, where c1 is a resonance point brought by the first radiator 1, and c2 is a resonance point brought by the second radiator 2.

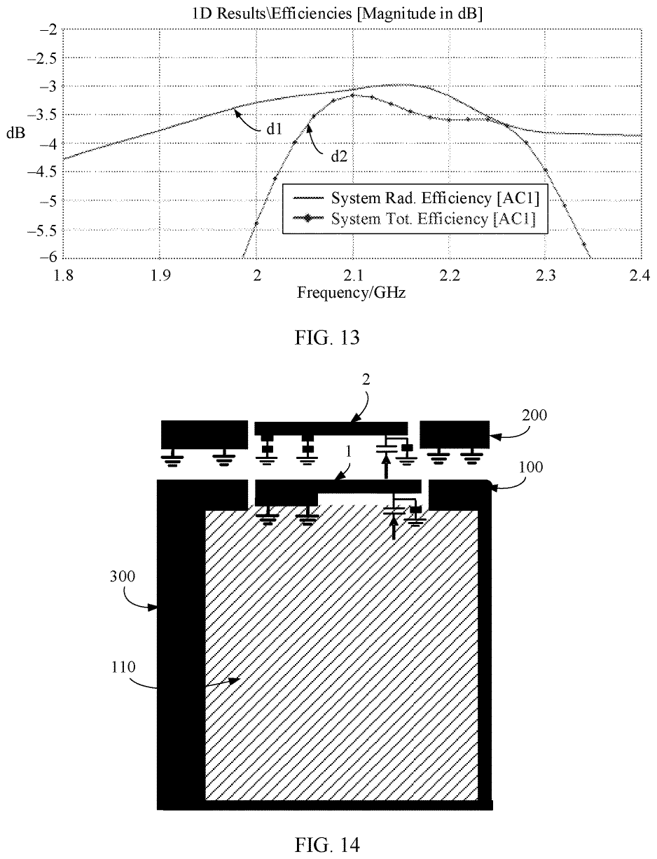

FIG. 13 is a diagram of an efficiency curve of an antenna apparatus in a magnetoelectric coupling mode according to an embodiment of this application. A horizontal coordinate is a frequency, and a vertical coordinate is efficiency. Refer to FIG. 13. A curve d1 is radiation efficiency of an antenna apparatus in the magnetoelectric coupling mode, and a curve d2 is system efficiency of the antenna apparatus in the magnetoelectric coupling mode. It can be learned from the curve d2 that, at positions corresponding to the resonance points c1 and c2 shown in FIG. 11, system efficiency of the antenna apparatus is greater than −3.6, and has high efficiency.

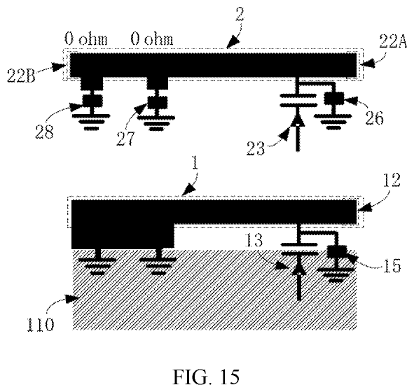

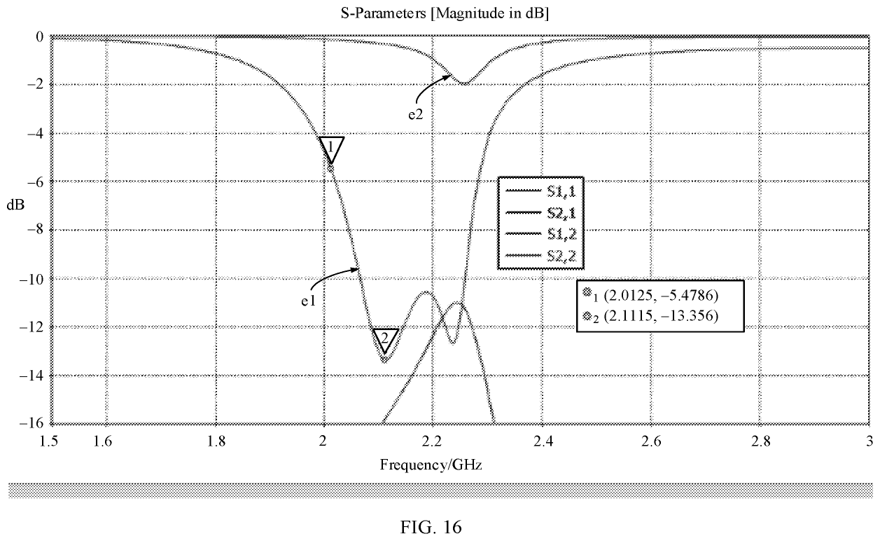

In an embodiment, FIG. 14 is a topological diagram of an electronic device according to a fifth embodiment of this application. FIG. 15 is a partial enlarged diagram of positions of the first radiator 1 and the second radiator 2 in FIG. 14. Refer to FIG. 15. The first tuning circuit 26 includes a radio frequency switch, the second tuning circuit 27 is 0 ohm, the fourth tuning circuit 28 is 0 ohm, and the second radiator 2 may be switched to a passive parasitic mode through the radio frequency switch, that is, an electrical parasitic mode. A resonance point generated by the second radiator 2 may be located at a higher frequency position in the resonance frequency band of the first radiator 1, so that radiation performance of the first radiator 1 can be improved. FIG. 16 is a diagram of a return loss curve of an antenna apparatus in an electronic device in an electrical parasitic mode according to a fifth embodiment of this application. A horizontal coordinate is a frequency, a vertical coordinate is a return loss, a curve e1 is a return loss of the first radiator 1, and a curve e2 is a return loss of the second radiator 2. Refer to FIG. 16. It can be learned that a resonance point generated by the second radiator 2 may be located at a higher frequency position in a resonance frequency band (2 GHz to 2.4 GHz) of the first radiator 1, thereby helping improve radiation performance of the first radiator 1.

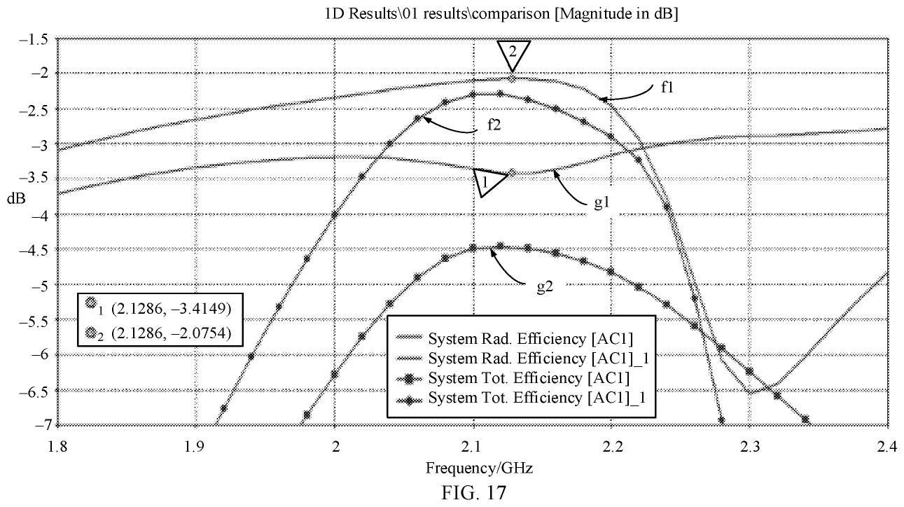

FIG. 17 is a comparison diagram of an efficiency curve of a first radiator 1 in an antenna apparatus in an electrical parasitic mode and an efficiency curve of the first radiator 1 in the antenna apparatus in a coexistence mode according to a fifth embodiment of this application. A horizontal coordinate is a frequency, a vertical coordinate is efficiency, a curve f1 is radiation efficiency of the first radiator 1 in the electrical parasitic mode, a curve f2 is system efficiency of the first radiator 1 in the electrical parasitic mode, a curve g1 is radiation efficiency of the first radiator 1 in the coexistence mode, and a curve g2 is system efficiency of the first radiator 1 in the coexistence mode. The coexistence mode is a mode in which the first radiator 1 and the second radiator 2 operate independently and normally when the electronic device is in the folded state, the first radiator 1 may generate the first resonance, and the second radiator 2 may generate the second resonance. Refer to FIG. 17. The radiation efficiency of the first radiator 1 in the electrical parasitic mode is 1.5 dB higher than the radiation efficiency in the coexistence mode, and the system efficiency is improved by 2 dB.

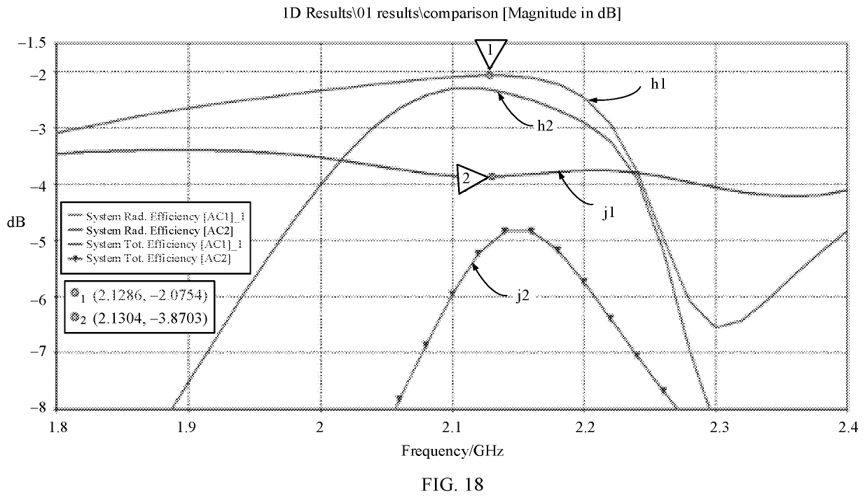

FIG. 18 is a comparison diagram of an efficiency curve of a second radiator 2 in an antenna apparatus in an electrical parasitic mode and an efficiency curve of the second radiator 2 in the antenna apparatus in a coexistence mode according to a fifth embodiment of this application. A horizontal coordinate is a frequency, a vertical coordinate is efficiency, a curve h1 is radiation efficiency of the second radiator 2 in the electrical parasitic mode, a curve h2 is system efficiency of the second radiator 2 in the electrical parasitic mode, a curve j1 is radiation efficiency of the second radiator 2 in the coexistence mode, and a curve j2 is system efficiency of the second radiator 2 in the coexistence mode. The coexistence mode is a mode in which the first radiator 1 and the second radiator 2 operate independently and normally when the electronic device is in the folded state. Refer to FIG. 17. The radiation efficiency of the second radiator 2 in the electrical parasitic mode is 1.8 dB higher than the radiation efficiency in the coexistence mode, and the system efficiency is improved by 3 dB.

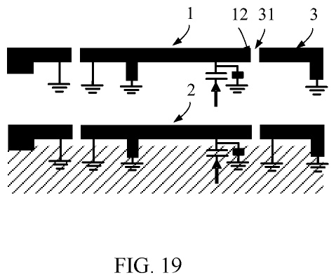

In an embodiment, FIG. 19 is a partial enlarged diagram of an electronic device at positions of the first radiator 1 and the second radiator 2 according to a sixth embodiment of this application. Refer to FIG. 19. The antenna apparatus further includes a parasitic stub 3, the parasitic stub 3 is disposed on a side that is of the first radiator 1 and that has a first open end 12, and there is a first gap 31 between the parasitic stub 3 and the first open end 12. No parasitic stub 3 is disposed on a side that is of the second radiator 2 and that has the second open end 22A. Alternatively, in another embodiment, the parasitic stub 3 is disposed on a side that is of the second radiator 2 and that has the second open end 22A, and there is a first gap 31 between the parasitic stub 3 and the second open end 22A. No parasitic stub 3 is disposed on a side that is of the first radiator 1 and that has the first open end 12. The first radiator 1 and the second radiator 2 have a same structure, and are symmetrically disposed on the corresponding first body 100 and second body 200. The parasitic stub 3 can attract a current, to create an asymmetric current path between the two radiators that are symmetric in structure and position, thereby generating a cancellation current, improving isolation between the two radiators in an independent operating process, and further expanding a bandwidth. In the electronic device, the parasitic stub 3 may be a part of a metal side frame of the electronic device. A corresponding break gap such as the first gap 31 may be disposed at a corresponding position on the metal side frame, to separately form the corresponding radiator and the parasitic stub 3. The parasitic stub 3 does not need to be separately prepared and mounted. This helps simplify a manufacturing process and save space in the electronic device.

The foregoing descriptions are merely preferred embodiments of this application, and are not intended to limit this application. For a person skilled in the art, this application may have various modifications and variations. Any modification, equivalent replacement, or improvement made without departing from the spirit and principle of this application shall fall within the protection scope of this application.

1. A foldable electronic device, wherein the electronic device comprises an antenna apparatus, a first body, a second body, and a rotating shaft, the first body and the second body are respectively disposed on two sides of the rotating shaft and are rotatively connected to the rotating shaft, the first body comprises a first ground plane, and the second body comprises a second ground plane, and wherein the antenna apparatus comprises:
a first radiator, disposed on the first body, wherein the first radiator is provided with a ground end and a first open end, the ground end is coupled to the first ground plane, and the first radiator comprises a first feeding point;
a first feeding circuit, coupled to the first radiator through the first feeding point, and configured to feed a signal of a first operating frequency band to the first radiator, wherein the first radiator is configured to generate a first resonance corresponding to the first operating frequency band;
a second radiator, disposed on the second body, wherein the second radiator is provided with a second open end, a third open end, and a first ground point located between the second open end and the third open end, the first ground point is coupled to the second ground plane, a ratio of a length of the second radiator between the second open end and the third open end to a length of the first radiator between the ground end and the first open end is greater than 1 and less than or equal to 2, and the second radiator comprises a second feeding point;
a second feeding circuit, coupled to the second radiator through the second feeding point, and configured to feed a signal of a second operating frequency band to the second radiator, wherein the second radiator is configured to generate a second resonance corresponding to the second operating frequency band, and the second operating frequency band is the same as or adjacent to the first operating frequency band; and
a first tuning circuit, wherein one end of the first tuning circuit is coupled to the second radiator, the other end is coupled to the second ground plane, and the first tuning circuit is configured to adjust the second resonance of the second radiator to correspond to the second operating frequency band, and
wherein when the electronic device is in a folded state, projections of the first open end and the second open end at least partially overlap in a thickness direction of the electronic device, and a projection of the ground end is located between a projection of the third open end and the projection of the second open end.

2. The foldable electronic device according to claim 1, wherein:
the second radiator comprises a second ground point, and the second ground point is disposed between the first ground point and the second feeding point; and
the antenna apparatus further comprises a second tuning circuit, wherein one end of the second tuning circuit is connected to the second ground point, and the other end is connected to the second ground plane.

3. The foldable electronic device according to claim 2, wherein when the electronic device is in the folded state, in the thickness direction of the electronic device, the projection of the ground end is at least partially located between a projection of the first ground point and a projection of the second ground point.

4. The foldable electronic device according to claim 2, wherein the second tuning circuit comprises at least one of a capacitor, an inductor, or a radio frequency switch, and is configured to adjust an efficiency dip of the second radiator.

5. The foldable electronic device according to claim 1, wherein the ground end is electrically connected to the first ground plane.

6. The foldable electronic device according to claim 1, wherein the first radiator, the ground end, and at least a part of the first ground plane are integrally formed.

7. The foldable electronic device according to claim 1, wherein an electrical length of the first radiator between the ground end and the first open end is 1/4λ, and λ is a wavelength corresponding to a range of the first operating frequency band.

8. The foldable electronic device according to claim 1, wherein an electrical length of the second radiator between the third open end and the second open end is between 1/4λ and 1/2λ, and λ is a wavelength corresponding to a range of the second operating frequency band.

9. The foldable electronic device according to claim 1, wherein the antenna apparatus further comprises a third tuning circuit, one end of the third tuning circuit is connected to the first radiator, and the other end of the third tuning circuit is connected to the first ground plane.

10. The foldable electronic device according to claim 9, wherein the third tuning circuit comprises at least one of a capacitor, an inductor, or a radio frequency switch, and is configured to adjust the first resonance to correspond to the first operating frequency band.

11. The foldable electronic device according to claim 9, wherein the first tuning circuit comprises a first inductor, the third tuning circuit comprises a second inductor, and an inductance value of the first inductor is less than an inductance value of the second inductor.

12. The foldable electronic device according to claim 1, wherein a distance between the first feeding point and the first open end is less than 7.5 mm, and a distance between the second feeding point and the second open end is less than 7.5 mm.

13. The foldable electronic device according to claim 1, further comprising a fourth tuning circuit, wherein one end of the fourth tuning circuit is connected to the first ground point, and the other end of the fourth tuning circuit is connected to the second ground plane.

14. The foldable electronic device according to claim 13, wherein the fourth tuning circuit comprises at least one of a capacitor, an inductor, or a radio frequency switch, and is configured to adjust an efficiency dip of the second radiator.

15. The foldable electronic device according to claim 1, further comprising a parasitic stub, wherein:
the parasitic stub is disposed on a side that is of the first radiator and that has the first open end, and there is a first gap between the parasitic stub and the first open end; or
the parasitic stub is disposed on a side that is of the second radiator and that has the second open end, and there is a first gap between the parasitic stub and the second open end.

16. The foldable electronic device according to claim 1, wherein a frequency of a resonance point of the first resonance is higher than a frequency of a resonance point of the second resonance.

17. The foldable electronic device according to claim 16, wherein a difference between the frequency of the resonance point of the first resonance and the frequency of the resonance point of the second resonance is less than or equal to 200 MHz.

18. The foldable electronic device according to claim 16, wherein:
the resonance point of the first resonance is within a range of 2.5 GHz to 2.7 GHz, and the resonance point of the second resonance is within a range of 2.4 GHz to 2.5 GHz;
the resonance point of the first resonance is within a range of 2.4 GHz to 2.5 GHz, and the resonance point of the second resonance is within a range of 2.3 GHz to 2.4 GHz; or
the resonance point of the first resonance is within a range of 1710 MHz to 2170 MHz, and the resonance point of the second resonance is within a range of 1575 MHz to 1630 MHz.

19. The foldable electronic device according to claim 1, wherein communication frequency bands corresponding to the signal of the first operating frequency band and the signal of the second operating frequency band are between 2.3 GHz and 2.7 GHz.

20. The foldable electronic device according to claim 1, wherein the first feeding circuit and the second feeding circuit operate at the same time to allow the first radiator to generate the first resonance and the second radiator to generate the second resonance at the same time.
